(19) United States
(12) Patent Application Publication
(10) Pub. No.: US 2015/0066194 A1
(43) Pub. Date: Mar. 5, 2015

(54) HOST DEVICE AND METHOD FOR OPTIMIZING MACHINING PROCESS OF PRODUCT

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: CHIH-KUANG CHANG, New Taipei (TW); XIN-YUAN WU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/059,457

(22) Filed: Oct. 22, 2013

(30) Foreign Application Priority Data
Aug. 28, 2013 (CN) 2013103792991

(51) Int. Cl. G05B 19/18

(52) U.S. Cl. CPC G05B 19/18; G05B 2219/45147; G05B 2219/32015
USPC 700/174

(57) ABSTRACT

In a method for optimizing a machining process of a product, a position deviation between a number of blades and a number of corresponding blade holes is corrected, and each blade is installed in the corresponding blade hole. One serial number is assigned to each blade and the corresponding blade hole. A principal axis of a computer numerical control (CNC) tool is controlled to return a currently used blade to the corresponding blade hole and equip another blade onto the CNC tool for a next step of the product machining process.

### BACKGROUND

1. Technical Field

The embodiments of the present disclosure relate to a host device and method for optimizing a machining process of a product.

2. Description of Related Art

Nowadays, products are usually machined by blades on a computer numerical control (CNC) tool. However, the blades are switched manually more than once, which wastes a lot of time.

### BRIEF DESCRIPTION OF THE DRAWINGS

FIG. 1 is a block diagram of one embodiment of a host device including a product machining optimization system.

FIG. 2 is a block diagram of one embodiment of function modules of the product machining optimization system in FIG. 1.

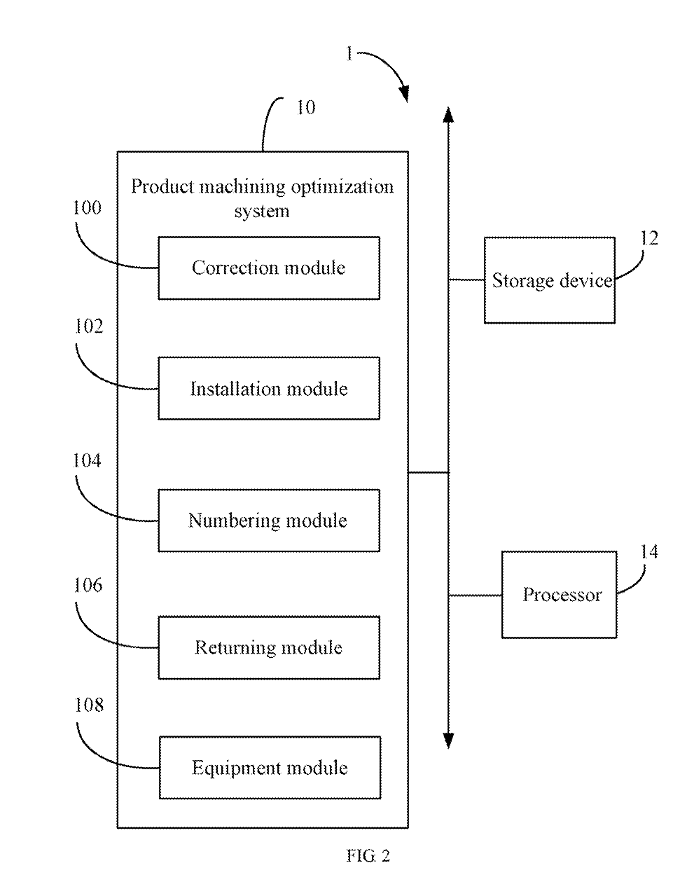

FIG. 3 is a flowchart of one embodiment of a method for optimizing machining of a product using the host device of FIG. 1.

FIG. 4 is a flowchart of one embodiment of a method for correcting a position deviation between each blades and its corresponding blade hole.

FIG. 5 is an example of a blade holder.

FIG. 6 is an example of a computer numerical control (CNC) tool.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module,” as used herein, refers to logic embodied in hardware or firmware, or to a collection of software instructions, written in a programming language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, flash memory, and hard disk drives.

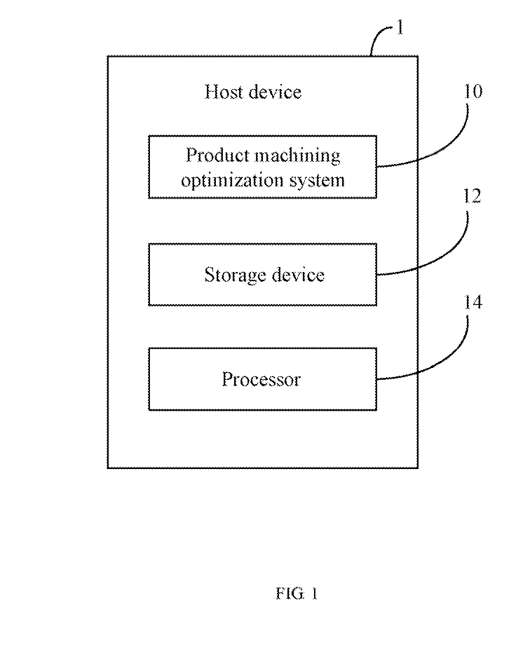

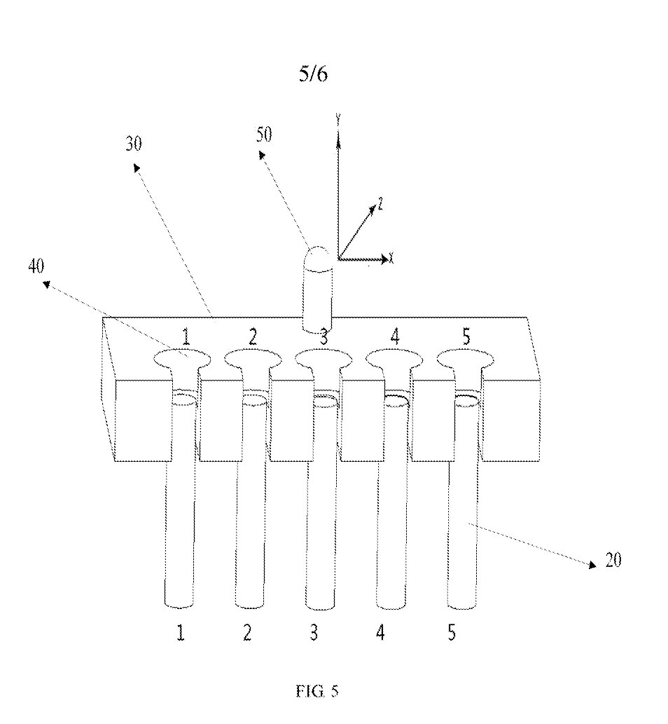

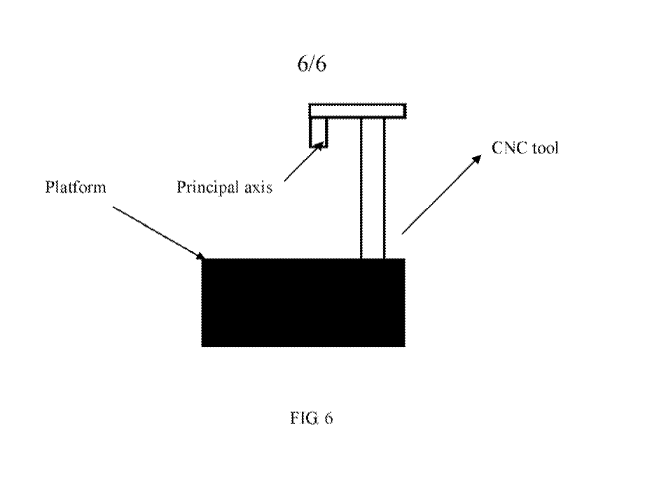

FIG. 1 is a block diagram of one embodiment of a host device 1 including a product machining optimization system 10. The host device 1 comprises a storage device 12 and at least one processor 14. In the embodiment, the host device 1 connects to a computer numerical control (CNC) tool as shown in FIG. 6. The CNC tool is an automated machining device that is operated by abstractly programmed commands and includes a principal axis and a platform. In one embodiment as shown in FIG. 5, the product is machined by a plurality of blades 20 controlled by the CNC tool, and each blade 20 is installed in a corresponding blade hole 40 of a blade holder 30. The blade holder 30 further has a location pole 50.

In one embodiment, the storage device 12 (non-transitory storage device) may be an internal storage system, such as a random access memory (RAM) for the temporary storage of information, and/or a read only memory (ROM) for the permanent storage of information. In some embodiments, the storage device 12 may be an external storage system, such as an external hard disk, a storage card, or a data storage medium.

The at least one processor 14 may include a processor unit, a microprocessor, an application-specific integrated circuit, and a field programmable gate array, for example.

In one embodiment, the product machining optimization system 10 includes a plurality of function modules which include computerized codes or instructions that can be stored in the storage device 12 and executed by the at least one processor 14 to provide a method for optimizing machining of a product.

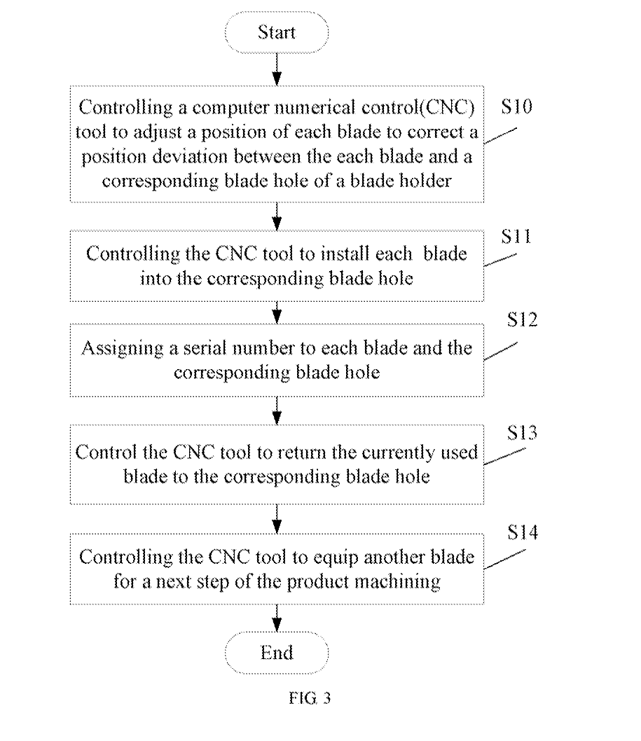

In one embodiment, the product machining optimization system 10 includes a correction module 100, an installation module 102, a numbering module 104, a returning module 106, and an equipment module 108. The modules may comprise computerized codes in the form of one or more programs that are stored in the storage device 12 and executed by the at least one processor 14 to provide functions for implementing the machining process optimization system 10. The functions of the function modules are illustrated in FIG. 3 and described below.

FIG. 3 illustrates a flowchart of one embodiment of a method for optimizing machining of a product using the host device 1 of FIG. 1. Depending on the embodiment, additional steps may be added, others removed, and the ordering of the steps may be changed.

In step S10, the correction module 100 controls the CNC tool to adjust a position of each blade 20 to correct a position deviation between each blade 20 and the corresponding blade hole 40.

In step S11, the installation module 102 controls the CNC tool to install each blade 20 in the corresponding blade hole 40. In the embodiment, the installation module 102 controls the CNC tool to install several blades 20 in a predetermined order and in a same direction to make it convenient to switch the blades 20 from the blade holder 30 during the machining process. In the embodiment, each blade 20 is installed in the blade holder 30, such that an axle direction of the blade 20 is substantially perpendicular to a platform of the CNC tool.

In step S12, the numbering module 104 assigns one serial number (1, 2, 3 . . . ) to each blade 20 and each corresponding blade hole 40.

In step S13, the returning module 106 controls the principal axis of the CNC tool to return the currently used blade 20 to the corresponding blade hole 40.

In step S14, the equipment module 108 controls the principal axis of the CNC tool to equip another blade 20 onto the CNC tool for a next step of the machining process. For example, the CNC tool is controlled to move to a side of the blade holder 30, and the principal axis of the CNC tool is controlled to return the currently used second blade 20 to the second blade hole 40 and equip the third blade 20 onto the CNC tool for a next step of the machining process.

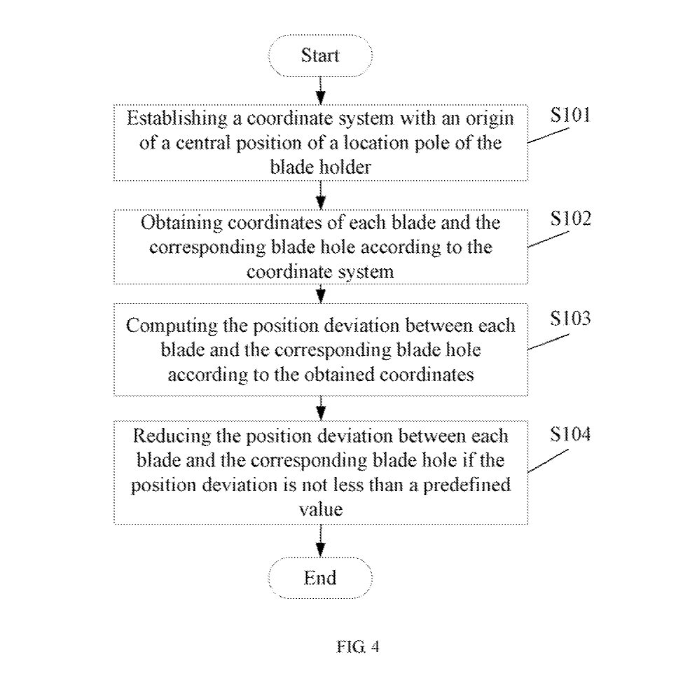

FIG. 4 illustrates a flowchart of one embodiment of a method for correcting a position deviation between each blade 20 and the corresponding blade hole 40. Depending on the embodiment, additional steps may be added, others removed, and the ordering of the steps may be changed.

In step S101, the correction module 100 establishes a coordinate system having an origin at a central position of the location pole 50 of the blade holder 30. In the embodiment, the coordinate system is a three-dimensional coordinate system as shown in FIG. 5.

In step S102, the correction module 100 obtains coordinates of each blade 20 and the corresponding blade hole 40 according to the coordinate system.

In step S103, the correction module 100 computes the position deviation between each blade 20 and the corresponding blade hole 40 according to the obtained coordinates.

In step S104, the correction module 100 controls the CNC tool to adjust a position of each blade 20 to reduce the position deviation between each blade 20 and the corresponding blade hole 40 if the position deviation is greater than a predefined value. In the embodiment, the predefined value is 0.002 millimeters (mm).

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A host device, comprising:
at least one processor; and
a storage device storing a computer program including instructions that, which executed by the at least one processor, causes the at least one processor to:
control a computer numerical control (CNC) tool to adjust a position of each blade to correct a position deviation between each blade and its corresponding blade hole of a blade holder;
control the CNC tool to install each blade into the corresponding blade;
assign a serial number to each blade and the corresponding blade hole;
control the CNC tool to return the currently used blade to the corresponding blade hole; and
control the CNC tool to equip another blade for a next step of the product machining

2. The host device according to claim 1, wherein the blades are installed in an order and in a same direction.

3. The host device according to claim 2, wherein each blade is installed on the blade holder with an axle direction of the each blade perpendicular to a platform of the CNC tool.

4. The host device according to claim 1, wherein the position deviation between each blade and its corresponding blade hole is corrected by the following steps:
establishing a coordinate system with an origin of a central position of a location pole of the blade holder;
obtaining coordinates of each blade and the corresponding blade hole according to the coordinate system;
computing the position deviation between each blade and the corresponding blade hole according to the obtained coordinates; and
reducing the position deviation between each blade and the corresponding blade hole if the position deviation is not less than a predefined value.

5. A method for optimizing a machining process of a product using a host device, the method comprising:
controlling a computer numerical control(CNC) tool to adjust a position of each blade to correct a position deviation between the each blade and its corresponding blade hole of a blade holder;
controlling the CNC tool to install each blade into the corresponding blade hole;
assigning a serial number to each blade and the corresponding blade hole;
control the CNC tool to return the currently used blade to the corresponding blade hole; and
controlling the CNC tool to equip another blade for a next step of the product machining.

6. The method according to claim 5, wherein the blades are installed in an order and in a same direction.

7. The method according to claim 6, wherein each blade is installed on the blade holder with an axle direction of the each blade perpendicular to a platform of the CNC tool.

8. The method according to claim 5, wherein the position deviation between the each blade and its corresponding blade hole is corrected by the following steps:
establishing a coordinate system with an origin of a central position of a location pole of the blade holder;
obtaining coordinates of each blade and the corresponding blade hole according to the coordinate system;
computing the position deviation between each blade and the corresponding blade hole according to the obtained coordinates; and
reducing the position deviation between each blade and the corresponding blade hole if the position deviation is not less than a predefined value.

9. A non-transitory computer-readable storage medium having stored thereon instructions being executed by a processor of a host device, causes the processor to perform a method for optimizing a machining process of a product using the host device, the method comprising:
controlling a computer numerical control (CNC) tool to adjust a position of each blade to correct a position deviation between the each blade and its corresponding blade hole of a blade holder;
controlling the CNC tool to install each blade into the corresponding blade hole;
assigning a serial number to each blade and the corresponding blade hole;
control the CNC tool to return the currently used blade to the corresponding blade hole; and
controlling the CNC tool to equip another blade for a next step of the product machining

10. The storage medium according to claim 9, wherein the blades are installed in an order and in a same direction.

11. The storage medium according to claim 10, wherein each blade is installed on the blade holder with an axle direction of the each blade perpendicular to a platform of the CNC tool.

12. The storage medium according to claim 9, wherein the position deviation between each blade and its blade hole is corrected by the following steps:
establishing a coordinate system with an origin of a central position of a location pole of the blade holder;
obtaining coordinates of each blade and the corresponding blade hole according to the coordinate system;
computing the position deviation between each blade and the corresponding blade hole according to the obtained coordinates; and
reducing the position deviation between each blade and the corresponding blade hole if the position deviation is not less than a predefined value.
